(19) United States
(12) Patent Application Publication
(10) Pub. No.: US 2009/0000601 A1
(43) Pub. Date: Jan. 1, 2009

(54) VEHICLE FUEL SUPPLY DEVICE

(75) Inventor: Minoru TAKATA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/947,448

(22) Filed: Nov. 29, 2007

(30) Foreign Application Priority Data
Jun. 28, 2007 (JP) 2007-170501

(51) Int. Cl. F02M 37/00

(52) U.S. Cl. 123/510

(57) ABSTRACT

A compact vehicle fuel supply device that reduces noise caused by excess fuel discharge from a pressure regulator in a simple manner is provided. The device includes a fuel tank, a fuel pump provided in the fuel tank to raise the pressure of fuel in the fuel tank, a case that accommodates the fuel pump, the pressure regulator supported by the case to regulate fuel emitted from the fuel pump at a prescribed pressure and discharge excess fuel from an outlet, and a noise silencing cup provided to cover the outlet of the pressure regulator and having a discharge hole used to discharge the excess fuel into the case.

### BACKGROUND OF THE INVENTION

1. Field of the Invention

The present invention relates to a vehicle fuel supply device that pumps fuel in a fuel tank to an injector or the like in an internal combustion engine for example in a motorcycle.

2. Description of the Related Art

In order to capture foreign matter such as dust contained in fuel and stably supply the fuel into an injector in a fuel injection device provided for example in an engine, the foreign matter in the fuel tank is removed by a relatively coarse strainer such as a nylon mesh material provided at the inlet of the fuel pump.

It has been widely known that the foreign matter passed through the strainer as well as friction dust generated by a brush, a commutator, and the like generated at the motor part of the fuel pump is captured by a high pressure filter such as a filtering element made of paper provided at the downstream side of the fuel pump (in the succeeding stage to the fuel pump in view of the fuel flow path).

The strainer described above is generally positioned at a so-called uppermost stream position in the fuel supply and therefore placed at the lowermost bottom part of the fuel tank so that the fuel can be supplied if the fuel in the fuel tank is scarce.

For a motorcycle, it is particularly necessary that the fuel can surely be sucked through the fuel pump unaffected if the fuel is scarce and the fuel level changes depending on increase/decrease in speed or changes in the posture.

It goes without saying that this is for preventing so-called discontinuous combustion of the engine, in which the remaining little amount of fuel moves to the front of the fuel tank while the vehicle slows down or drives down a hillside, the strainer is exposed above the fuel level, and the engine speed cannot be raised even by turning the accelerator after that.

According to the disclosure of WO2006/134641 (paragraph 0019, FIG. 5), for example, excess fuel returned from the fuel supply system is retained in a fuel retaining chamber, and the fuel retained in the fuel retaining chamber is distributed to a filter storing chamber by communicating means, so that fuel can be distributed to the filter storing chamber from the fuel retaining chamber and the fuel can be supplied safely to the fuel supply system of the internal combustion engine.

On the other hand, according to the disclosure of WO2006/134641, pressurized excess fuel discharged from the pressure regulator to the fuel retaining chamber is likely to cause a large flow noise when it is discharged into the atmospheric pressure from the narrow flow path.

This is because the fuel pressurized to several hundred kilo Pascals by the fuel pump is lowered to the atmospheric pressure at one time for a short distance. Therefore, countermeasures against the flow noise, in other words, the countermeasures against the noise caused by excess fuel discharge from the pressure regulator should be necessary.

This is necessary because recent technological development has significantly reduced the vibration or noise of the engine, and the quietness of the vehicle has much improved accordingly.

More specifically, the sensibility quality of the vehicle greatly depends on the quietness, and the noise caused by the excess fuel discharge as described above cannot be ignored as an exception. The noise propagated through the fuel tank lowers the sensibility quality, in other words, the noise can make the driver and the others feel insecure or uncomfortable. Such reduction in the comfortableness and the quality as a commodity must be avoided.

According to the disclosure of JP-A-2004-44559 (paragraph 0014, FIGS. 1 to 3), the outlet for the excess fuel from the pressure regulator is directed to the inner wall of a flange, a distributor used to alleviate impact against the inner wall is provided integrally with the inner wall, so that the noise is reduced.

According to the disclosure of JP-A-2004-44559, from the lower side to the upper side in FIG. 2, in other words, to the flow path along the axial direction of the fuel pump, the outlet for the excess fuel from the pressure regulator is directed perpendicularly to the axial direction, so that the excess fuel can be discharged toward the inner wall as described above.

Stated differently, in the pressure regulator, the capability of keeping the fuel pressure at a prescribed value and the capability of turning and discharging the excess fuel substantially at right angles are both achieved.

This complicates the structure of the pressure regulator, which gives rise to cost increase, and if such a pressure regulator is applied to a fuel supply device for a motorcycle such as the device disclosed by WO2006/134641, the device should be more complex in structure or increased in size in order to rearrange the flow path. Therefore, a so-called compact fuel supply device that could be inserted/mounted to the limited opening of the fuel tank would not be provided.

Regarding the noise caused by excess fuel discharge from the pressure regulator, the excess fuel may certainly be regulated and the noise may surely be reduced according to JP-A-2004-44559, but the space from the outlet to the distributor is not along any flow path, the flow noise problem described above is still unsolved, and further improvement is required.

### SUMMARY OF THE INVENTION

The present invention is directed to a solution to the problem described above, and it is an object of the invention to provide a compact vehicle fuel supply device that reduces noise caused by excess fuel discharge from the pressure regulator in a simple manner.

A vehicle fuel supply device according to the invention includes a fuel tank, a fuel pump provided in the fuel tank to pressurize fuel in the fuel tank, a case that accommodates the fuel pump, a pressure regulator supported by the case to regulate fuel emitted from the fuel pump at a prescribed pressure and discharge excess fuel from an outlet, and a noise silencing cup provided to cover the outlet of the pressure regulator and having a discharge hole used to discharge the excess fuel into the case.

According to the invention, a compact vehicle fuel supply device that reduces noise caused by excess fuel discharge from the pressure regulator in a simple manner can be provided, and the invention can particularly contribute to improvement of the sensibility quality of a motorcycle.

The foregoing and other objects, features, aspects, and advantages of the present invention will become more apparent from the following detailed description of the invention when taken in conjunction with the accompanying drawings.

### BRIEF DESCRIPTION OF THE DRAWINGS

FIG. 1 is a general perspective view of a vehicle fuel supply device according to a first embodiment of the invention;

FIG. 2 is a side view of the vehicle fuel supply device according to the first embodiment including a section of its essential part;

FIG. 3 is a sound pressure-voltage characteristic graph representing an example of the effect of silencing by the vehicle fuel supply device according to the first embodiment;

FIG. 4 is a side view of a vehicle fuel supply device according to a second embodiment of the invention including a section of its essential part;

FIG. 5 is a general perspective view of a noise silencing cup according to the second embodiment; and

FIG. 6 is a side view of a vehicle fuel supply device according to a third embodiment of the invention including a section of its essential part.

### DETAILED DESCRIPTION OF THE PREFERRED EMBODIMENTS

### First Embodiment

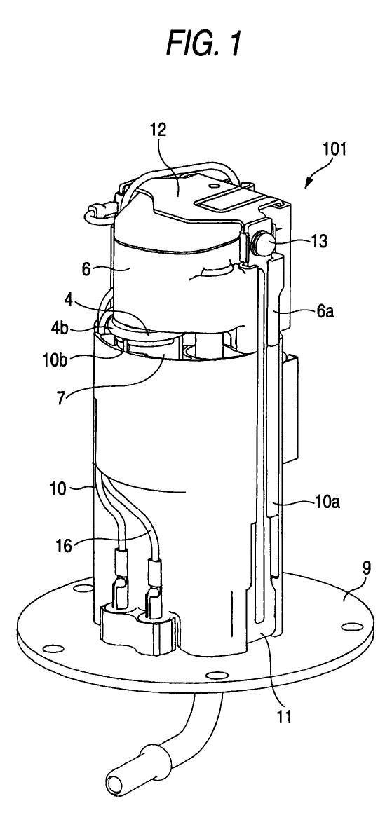

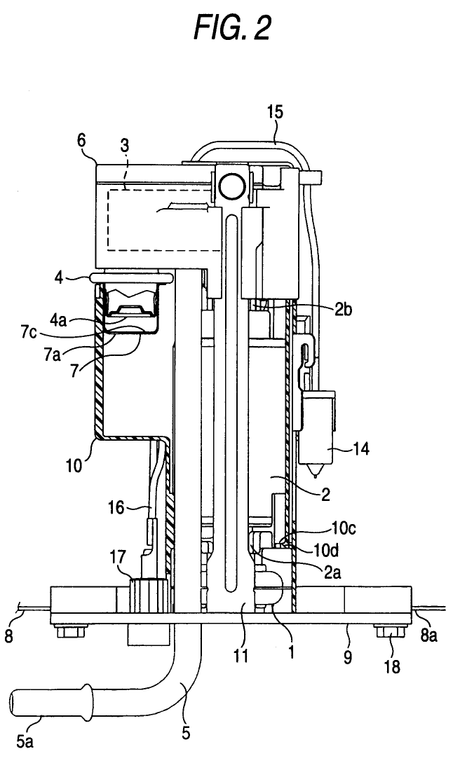

FIG. 1 is a general perspective view of a vehicle fuel supply device (hereinafter referred to as “fuel supply device”) according to a first embodiment of the invention, and FIG. 2 is a side view of the fuel supply device in FIG. 1 as it is provided in the fuel tank of a vehicle such as a motorcycle including a section of its essential part.

In the general view in FIG. 1, the fuel supply device 101 mainly includes a flange portion 9, an insulating resin case 10 having a groove 10a fitted to a stay 11 fixed to the flange portion 9 and sliding downwardly on the surface of the sheet to be abutted against the flange portion 9, an insulating resin filter case 6 having a groove 6a fitted and similarly sliding downwardly on the surface of the sheet to be abutted against the case 10, and a stopper 12 covering the upper surface of the filter case 6 and threadably mounted to the stay 11 by a screw 13 so that the case 10 and the filter case 6 are inserted and provided in the position on the surface of the sheet (so that they can be prevented from being pulled out upwardly).

As for functions, as shown in FIG. 2, the case 10 includes a partitioning wall 10d that separates a fuel pump 2 and a suction filter 1 similarly to the disclosure of WO2006/134641, and therefore the fuel pump 2 is inserted from above and the suction filter 1 is inserted from below, so that the suction filter 1 is mounted in the suction portion 2a of the fuel pump 2 in a liquid-tight manner and then the case 10 is fitted to the stay 11.

While an outlet pipe 5 is fixed to the flange portion 9 and therefore when the filter case 6 including a high pressure filter 3 is fitted into the stay 11, the outlet pipe 5 and the outlet portion 2b of the fuel pump 2 are mounted to the respective holes provided to the filter case 6 in a liquid-tight manner.

Note that the filter case 6 is provided with a hole used to mount a pressure regulator 4 in a liquid-tight manner. Therefore, the pressure regulator 4 is mounted therein and then the filter case 6 is fitted into the stay 11 as described above.

The outlet pipe 5 is bent to be substantially parallel to the flange 9 under the flange 9 and its tip end is processed as a connection portion 5a so that a hose (not shown) connected to the injector of the internal combustion engine can readily be mounted/detached to/from the end.

A liquid level detector 14 is provided at a side surface of the filter case 6 to constantly check the level of the fuel in the fuel tank 8. A lead wire 15 used to obtain the check signal is connected to a connector 17 provided in the flange portion 9 together with a lead wire 16 (see FIG. 2) for driving the fuel pump 2, so that the wires are connected to a control circuit or a battery (not shown) through the connector 17.

The fuel supply device 101 having the above-described structure is provided at the fuel tank 8 as it is inserted into the opening 8a of the fuel tank 8 from the side of the filter case 6, the flange portion 9 is fixed to the fuel tank 8 by bolts 18 through a packing that is not shown and the fuel tank 8a is blocked.

Now, the operation of the fuel supply device 101 will be described.

When the fuel pump 2 is driven through the connector 17, the rotation of a rotor (not shown) in the fuel pump 2 allows fuel in the fuel tank 8 to be removed of foreign matter through the suction filter 1, then pressurized/sucked into the suction portion 2a and discharged from the outlet 2b.

The discharged fuel has the foreign matter passing through the suction filter 1 or other foreign matter including friction powder (generated by a brush and a commutator at a motor portion (not shown) that forms the fuel pump 2) captured by the high pressure filter 3 and then supplied to the injector of the internal combustion engine through the outlet pipe 5 and then the hose (not shown).

When the pressure of the fuel in the filter case 6 is higher than a prescribed value, the fuel is discharged to the case 10 through the pressure regulator 4, so that the pressure is kept at the prescribed value.

The fuel discharged into the case 10 is fed back to the suction filter 1 through a flow path 10c provided at the partitioning wall 10d similarly to the disclosure of WO2006/134641. The feed back allows the fuel pump 2 to carry out pressurization and suction again by the suction portion 2a. Therefore, if the fuel level is lowered, and the suction filter 1 is exposed by the tilt of the vehicle body, the fuel can continue to be supplied to the injector.

As can be clearly understood from WO2006/134641 and its FIG. 2, excess fuel from the pressure regulator is directly discharged to the chamber 100 (that corresponds to the case 10 according to the first embodiment of the invention). On the other hand, according to the invention, as shown in FIG. 1, during assembly, a cylindrical noise silencing cup 7 made of polyacetal resin or the like having a bottom is provided on the upper end surface of the case 10 on the surface of the sheet, and then the filter case 6 including the pressure regulator 4 is fitted to the stay 11.

As shown in FIG. 1, in this way, the pressure regulator 4 has its rim portion 4b supported by the case 10 through the noise silencing cup 7, so that the outlet 4a of the pressure regulator 4 is covered with the noise silencing cup 7 and opposed to the bottom surface 7c as shown in FIG. 2.

At the bottom surface 7c of the noise silencing cup 7, a discharge hole 7a is provided in a position that does not match the axial direction of the outlet 4a of the pressure regulator 4, and therefore excess fuel has its stream line bent and is discharged into the case 10.

Therefore, the flow noise is absorbed in the cup 7 and the direction of the excess fuel is changed and regulated from the outlet 4a to the discharge hole 7a, so that the noise of the flow discharged to the case 10 can be reduced.

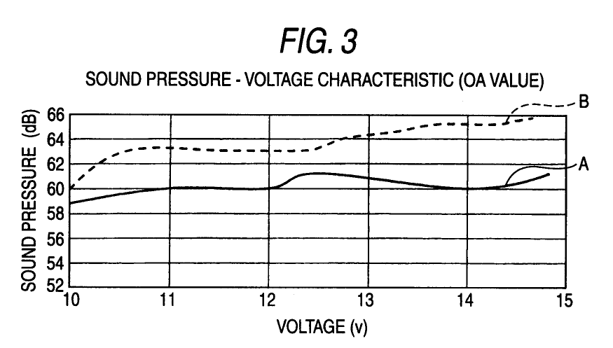

FIG. 3 is a sound pressure-voltage characteristic graph that indicates an example of the silencing effect by the fuel supply device according to the first embodiment. The characteristic A corresponds to the case in which the noise silencing cup 7 is mounted and the characteristic B corresponds to the case in which the noise silencing cup 7 is not mounted. As can be clearly understood from the example, the sound pressure in the case with the noise silencing cup 7 is lower than that in the case without the noise silencing cup 7 by about 3 dB.

Note that according to the first embodiment, the case 10 and the noise silencing cup 7 are made as different components, while they don't have to be separate and the noise silencing cup 7 may be formed simultaneously when the case 10 is formed. In view of the case 10 having the bottom to serve as a kind of a fuel retaining chamber, however, they are preferably formed as separate components in order to form them or produce dies for them in a simple manner.

The axial line of the fuel pump 2 and the axial line of the pressure regulator 4 are separated. More clearly stated, when seen from above on the surface of the sheet, the fuel pump 2 and pressure regulator 4 are not lapped, while if there is a space in the height-wise direction, the axial lines are placed closer. In other words, as shown in FIG. 2 of WO2006/134641, if the fuel pump 2 and the pressure regulator 4 are lapped when viewed from above on the surface of the sheet, the flange 9 can be reduced in size, so that the opening area of the opening 8a can be reduced, which is more preferable.

### Second Embodiment

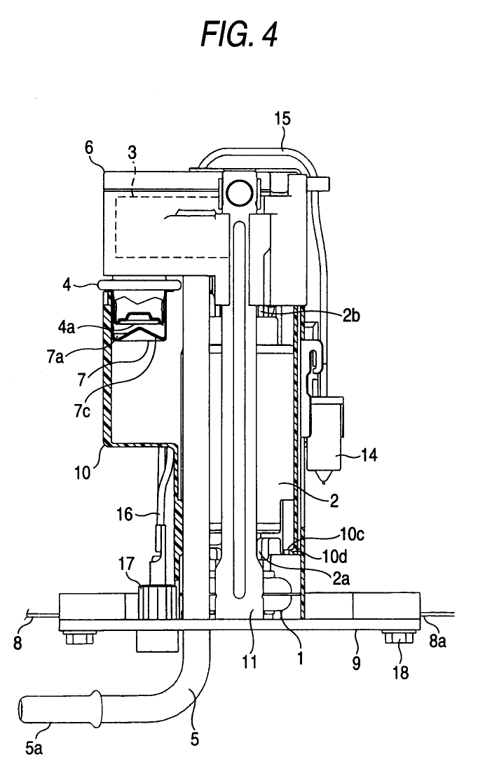

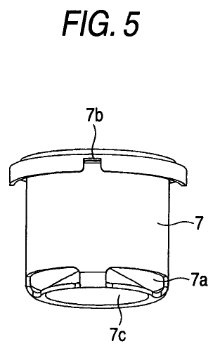

FIG. 4 is a side view of a vehicle fuel supply device according to a second embodiment of the invention including a section of its essential part, and FIG. 5 is a general perspective view of a noise silencing cup according to the second embodiment.

According to the first embodiment, the bottom surface 7c of the noise silencing cup 7 is placed horizontally or perpendicularly to the axial direction of the pressure regulator 4, but as shown in FIG. 4, if the bottom surface 7c is raised inside in a cone shape, an increased effect of regulating excess fuel can be expected.

In consideration of the close positioning of the inner wall of the case 10 and the outer wall of the noise silencing cup 7, the discharge hole 7a is provided opposed to the inner wall of the case 10.

In this way, the excess fuel is allowed to flow and drop toward the flow path 10c along the inner wall of the case 10, so that not only the regulating effect and the flow noise attenuation similarly to the first embodiment, but also the effect of removing bubbles in the fuel in the flow path 10c disclosed by WO2006/134641 is provided at the discharge hole 7a opposed to the inner wall of the case 10.

Therefore, the fuel pump 2 can suck fuel containing reduced bubbles through the suction filter 1, so that a discharge fault in the fuel pump 2 caused by such bubbles sucked into the pump and discontinuous combustion by the internal combustion engine attributable to the fault can be prevented.

Note that according to the second embodiment, the position of the noise silencing cup 7 is limited and therefore the noise silencing cup 7 must be positioned in the case 10 or provided with a whirl-stop.

Therefore, according to the second embodiment, a raised portion 10b (see FIG. 1) is provided at the upper end of the case 10, and a recessed portion 7b is provided at the rim portion of the noise silencing cup 7 as shown in FIG. 5 so that the discharge hole 7a is opposed to the inner wall of the case 10 as the noise silencing cup 7 is placed at the case 10.

During assembly, the raised portion 10b and the recessed portion 7b are engaged with each other, so that the noise silencing cup 7 is placed in a prescribed position. This makes the assembly easier and the above-described advantages can surely be obtained.

### Third Embodiment

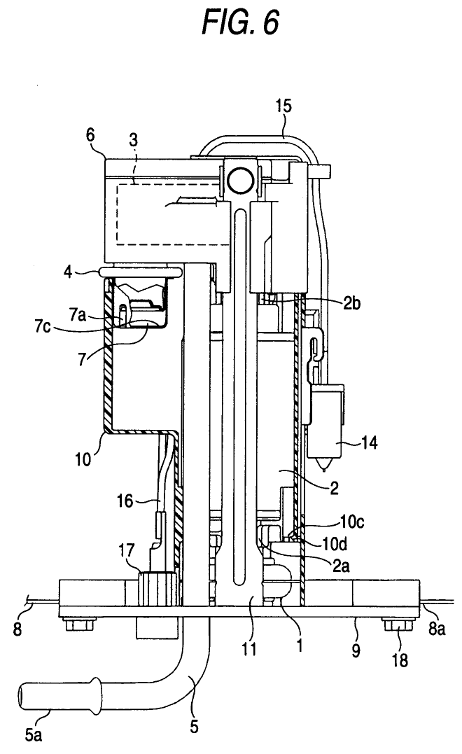

FIG. 6 is a side view of a vehicle fuel supply device according to a third embodiment of the invention including a section of its essential part.

According to the first and second embodiments described above, the excess fuel is discharged downwardly on the surface of the sheet, while according to the third embodiment, the discharge hole 7a is provided at a side surface and the excess fuel is discharged toward the front side (or in the depth-wise direction) on the surface of the sheet and then allowed to drop toward the flow path 10c.

In this case, the advantage of the second embodiment, in other words, the effect of removing bubbles slightly degrades, but when for example the flow path of the excess fuel is from the lower side to the upper side on the surface of the sheet, or more simply stated, if the outlet of the pressure regulator 4 is replaced by the one provided in the axial direction with reference to FIG. 2 in JP-A-2004-44559 (as can be clearly understood from the described object of the invention, the pressure regulator 4 can be less costly produced in this way), the noise silencing cup 7 is reversely placed on the pressure regulator 4, so that the excess fuel is impinged upon the bottom 7c (ceiling) of the noise silencing cup 7, regulated, and then discharged from the discharge hole 7a. Therefore, reduction in the flow noise can equally be expected.

If the direction of the flow path is reversed in this way, the noise silencing cup having the bottom is provided opposed to the outlet of the pressure regulator 4, and therefore the invention can be applied in the same manner.

Various modifications and alterations of this invention will be apparent to those skilled in the art without departing from the scope and spirit of this invention, and it should be understood that this is not limited to the illustrative embodiments set forth herein.

What is claimed is:

1. A vehicle fuel supply device, comprising:
a fuel tank;
a fuel pump provided in the fuel tank to raise the pressure of fuel in the fuel tank;
a case that accommodates the fuel pump;
a pressure regulator supported by the case to regulate fuel emitted from the fuel pump at a prescribed pressure and discharge excess fuel from an outlet; and
a noise silencing cup provided to cover the outlet of the pressure regulator and having a discharge hole used to discharge the excess fuel into the case.

2. The vehicle fuel supply device according to claim 1, wherein the discharge hole of the noise silencing cup is provided in a position different from the axial direction of the outlet.

3. The vehicle fuel supply device according to claim 2, wherein the bottom surface of the noise silencing cup is raised inwardly in a cone shape.

4. The vehicle fuel supply device according to claim 2, wherein the discharge hole of the noise silencing cup is provided opposed to the inner wall of the case.

5. The vehicle fuel supply device according to claim 4, wherein the noise silencing cup is provided in a prescribed position by an engaging portion that engages with the case.

6. The vehicle fuel supply device according to claim 2, wherein the noise silencing cup has the discharge hole on its side surface and has the excess fuel impinged upon its bottom surface and then discharged from the discharge hole.
